(19) United States
(12) Patent Application Publication
(10) Pub. No.: US 2020/0175614 A1
(43) Pub. Date: Jun. 4, 2020

(54) ELECTRIC VEHICLE CHARGING STATION HAVING REVERSE TIERED DISCOUNT INCENTIVE

(71) Applicant: International Business Machines Corporation, Armonk, NY (US)

(72) Inventors: Jeremy R. Fox, Georgetown, TX (US); Lisa Seacat DeLuca, Baltimore, MD (US); Jeremy A. Greenberger, San Jose, CA (US); Kelley Anders, East New Market, MD (US)

(21) Appl. No.: 16/203,739

(22) Filed: Nov. 29, 2018

(51) Int. Cl. G06Q 50/06; G06Q 30/02

(52) U.S. Cl. CPC G06Q 50/06; G06Q 30/0237; B60L 11/1861; B60L 11/1848; B60L 11/1816

(57) ABSTRACT

A charging station and method of operation of electric vehicle charging stations which incentivizes users of the charging station to minimize the time spent at the charging station by offering discounts for spending less time at the station, where the discount or multiple tiers of discounts are based upon dynamic factors.

### BACKGROUND

The present invention relates to charging stations for electric vehicles, and more specifically to methods for charging stations and methods of operating charging stations which reduce the time required for charging by offering discounts to users based on multiple factors.

Electric vehicles are quickly growing in popularity and the charging stations cannot be built fast enough to accommodate the growing demand Optimizing the charging experience for all users/drivers across the entire population would be highly beneficial to the greater good of the total population.

Currently, there are a limited number of charging stations that can accommodate electric automotive vehicles, and some users will be faced with waiting in lines to charge their vehicles. If a possible incentive discount to vehicle owners/drivers to reduce their charging times was to be provided, this would partially relieve the long wait times for people waiting to charge their vehicles.

As an example of a current system of electric vehicle charging, Tesla® supercharging stations charge with up to 145 kW of power distributed between two adjacent cars, with a maximum of 120 kW per car. That is up to 16 times as fast as public charging stations; they take about 20 minutes to charge to 50%, 40 minutes to charge to 80%, and 75 minutes to 100%.

It has been known to offer discounts to users of charging stations based on time of day, in order to shift electric consumption to off-peak demand hours. US Published Application 2015/0046222 is one such system, in which rebates are offered to urge users not to charge vehicles during the summer weekday peak hours of 9:00 AM to 3:00 PM. This is similar to the off-peak meter rates, which have been offered by electric utilities to homes for many years, which offer lower rates at night to shift electric usage for high-demand appliances such as water heaters to times when demand on the system is low. These systems are based on static factors such as time of day (and possibly season) which apply to all vehicles or homes equally, and are not concerned with optimizing the experience of the individual driver at the charging station.

It has also been known to offer discounts to users of charging stations based on charging rate, such as disclosed in US Published Patent Application 2016/0075248. Systems such as this attempt to reduce peak power demand on the charging station by offering discounts to encourage users to take longer at the charging station by using electricity at a slower rate or waiting at the charger for lower-rate periods. As with the time of day systems discussed above, these factors are static—all users are offered discounts based on rate of charge—and aimed at optimizing the cost of power and demand charges. The effect of this system is, in fact, the opposite of that envisioned by the present disclosure in that it incentivizes spending more time at the charger, rather than less.

### SUMMARY

According to one embodiment of the present invention, a method of operating a charging station for an electric vehicle having a user and a battery having a charge is disclosed. The method comprising the steps of: a) accepting a connection initiated by the user of the vehicle connecting the vehicle to the charging station; b) notifying the user of the connection via a display device; c) determining at least one incentive-based discount based on at least one dynamic factor, the at least one discount being determined at least to incentivize the user toward spending less time at the charging station; d) displaying the at least one incentive-based discount to the user through the display device; e) accepting a user input; f) determining an applicable discount from the user input; and g) applying the discount.

According to another embodiment of the present invention, a computer program product for operating a charging station for an electric vehicle having a user and a battery having a charge is disclosed. A computer of the charging station comprising at least one processor, one or more memories, one or more computer readable storage media, the computer program product comprising a computer readable storage medium having program instructions embodied therewith, the program instructions executable by the computer to perform a method comprising program instructions of: a) accepting, by the computer, a connection initiated by the user of the vehicle connecting the vehicle to the charging station; b) notifying, by the computer, the user of the connection via a display device; c) determining, by the computer, at least one incentive-based discount based on at least one dynamic factor, the at least one discount being determined at least to incentivize the user toward spending less time at the charging station; d) displaying, by the computer, the at least one incentive-based discount to the user through the display device; e) accepting, by the computer, a user input; f) determining, by the computer, an applicable discount from the user input; and g) applying, by the computer, the discount.

According to another embodiment of the present invention, a computer system for operating a charging station for an electric vehicle having a user and a battery having a charge is disclosed. The charging station comprising a computer comprising at least one processor, one or more memories, one or more computer readable storage media having program instructions executable by the computer to perform the program instructions comprising: a) accepting, by the computer, a connection initiated by the user of the vehicle connecting the vehicle to the charging station; b) notifying, by the computer, the user of the connection via a display device; c) determining, by the computer, at least one incentive-based discount based on at least one dynamic factor, the at least one discount being determined at least to incentivize the user toward spending less time at the charging station; d) displaying, by the computer, the at least one incentive-based discount to the user through the display device; e) accepting, by the computer, a user input; determining, by the computer, an applicable discount from the user input; and g) applying, by the computer, the discount.

### BRIEF DESCRIPTION OF THE DRAWINGS

FIG. 1 shows a block diagram of an electric vehicle charging station environment in which illustrative embodiments may be implemented.

FIG. 2 shows a flowchart of a method of operating an electric vehicle charging station.

FIG. 3a shows a graph of conventional incentives.

FIG. 3b shows a graph of possible incentive embodiment

FIG. 3c shows a graph of possible incentive embodiment.

FIG. 4 shows a screen display on a charging station.

FIG. 5 shows internal and external components of a device computer and server computer in which illustrative embodiments may be implemented.

### DETAILED DESCRIPTION

The charging station and method of operation described herein reduces the required time someone might spend at a charging station by offering discounts to users of electric vehicle charging stations based upon multiple factors, incentivizing electric vehicle drivers to reduce their charging time of their electric vehicle at charging station(s) based on potential discounts. The incentive, which may be a promotional product or services advertisement, can be varied based on the accumulated length of stay at a charging station, and discounts can be decreased as time progresses. The advertisements and temporal promotional discounts are dynamically tailored to each vehicle and driver. A “pop-up” interactive text message can be added when the vehicle is parked.

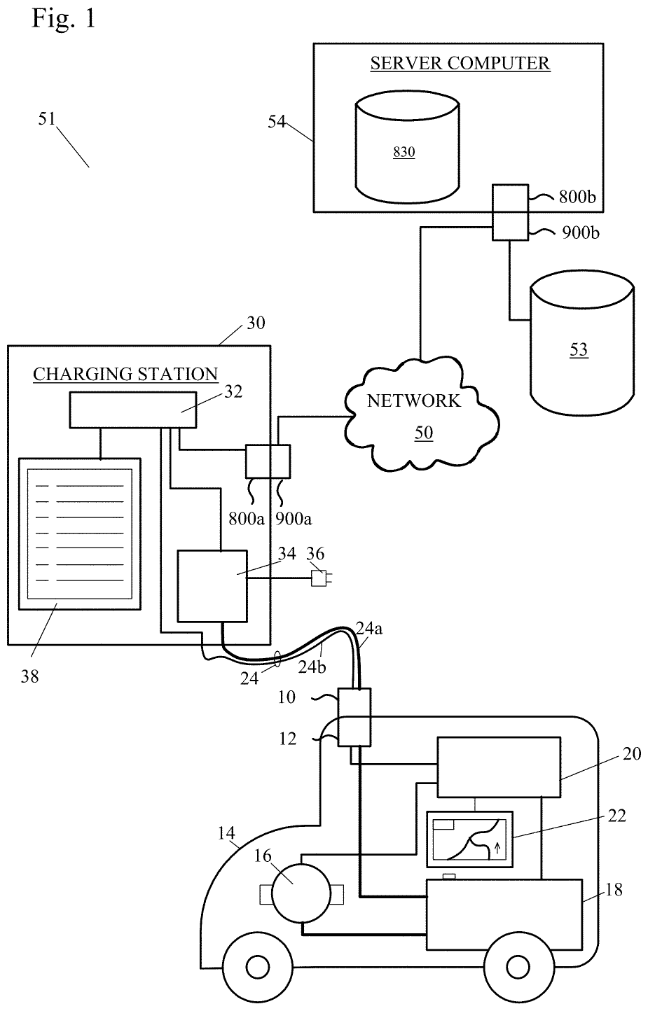

FIG. 1 is an exemplary diagram of a possible electric vehicle charging station environment in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, electric vehicle charging station system 51 is a network of computers in which illustrative embodiments may be implemented. Electric vehicle charging station system 51 contains network 50, which is the medium used to provide communication links between various devices and computers connected together within , electric vehicle charging station system 51. Network 50 may include connections, such as wire, wireless communication links, or fiber optic cables.

In the example of FIG. 1, electric vehicle 14 has a battery 18 for storing electrical power and a motor 16 to operate the vehicle, which draws power from the battery 14. A vehicle computer 20 has a driver interface 22 for displaying information to a driver and accepting commands from the driver. The computer 20 is linked to the battery 18 for monitoring the battery charge state and to motor 16 to monitor motor condition and control motor output, and, optionally, to charging socket 12. The vehicle computer 20 may also do many other things to monitor and control the vehicle as is known to the art. The electric vehicle 14 is shown in illustrative block diagram form only, and is not intended to represent any particular vehicle or vehicle type. The term “electric vehicle” is intended to encompass pure electric vehicles as well as plug-in hybrid vehicles which have auxiliary internal combustion engines either to drive the vehicle or charge the battery when battery power is exhausted, as well as other technologies which might be developed in the future, so long as the vehicle is capable of being connected to a charging station to accept an electrical charge.

In the depicted example, charging station 30, a repository 53, and a server computer 54 connect to network 50. In other exemplary embodiments, the electric vehicle charging station system 51 may include additional client or device computers, storage devices or repositories, server computers, and other devices not shown.

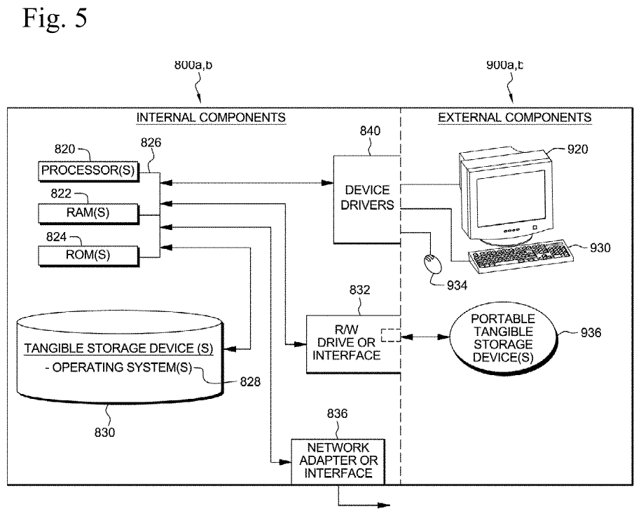

The charging station 30 may contain an interface 38, which may display information and accept commands and data entry from a user. The commands may be regarding charging the electric vehicle 14. The interface can be, for example, a command line interface, a graphical user interface (GUI), a natural user interface (NUI) or a touch user interface (TUI). The charging station 30 includes a set of internal components 800a and a set of external components 900a, further illustrated in FIG. 5. The charging station 30 has a control computer 32, which is linked to the interface 38, the internal components 800a, and a charger 34. The charger 34 is powered by the AC line 36, and converts AC line power into charging power for the electric vehicle 14. As is known to the art, the charger 34 has a high-current circuit 24a as part of a charging cord 24 which terminates in a plug 10 which is adapted to mate with a socket 12 on the vehicle 14. In some embodiments, charging station computer 32 may also have a data circuit 24b as part of the charging cord 24, which can also terminate in plug 10 and connect to socket 12 on the vehicle 14. Alternatively, data circuit 24b could possibly have a separate data plug connecting with a separate data socket in the vehicle 14, as will be recognized by one skilled in the art. Charging station 32 may include a program 66.

Server computer 54 includes a set of internal components 800b and a set of external components 900b, and one or more data storage devices 830, as illustrated in FIG. 5. In the depicted example, server computer 54 provides information, such as boot files, operating system images, and applications to the charging station 30. Server computer 54 can compute the information locally or extract the information from other computers on network 50. The server computer 54 may contain programs to upload software and control commands to charging station computer 32, to communicate with charging station customers and vehicles, programs to store and retrieve data from charging station computer 32, accounting programs to track usage by customers at charging stations 30 and to bill the customers, programs to interface with registers and terminals at stores and other facilities which have charging stations 30, and/or programs to communicate with vendors.

Program code and programs may be stored on at least one of one or more computer-readable tangible storage devices 830 shown in FIG. 5, on at least one of one or more portable computer-readable tangible storage devices 936 as shown in FIG. 5, or on storage unit 53 connected to network 50, or may be downloaded to a charging station 30 or server computer 54, for use. For example, program code and programs may be stored on at least one of one or more storage devices 830 on server computer 54 and downloaded to charging station 30 over network 50 for use. Alternatively, server computer 54 can be a web server, and the program code, and programs may be stored on at least one of the one or more storage devices 830 on server computer 54 and accessed charging station 30. In other exemplary embodiments, the program code, and programs may be stored on at least one of one or more computer-readable storage devices 830 on charging station 30 or distributed between two or more servers.

In the depicted example, network 50 represents the Internet, a worldwide collection of networks and gateways that use the Transmission Control Protocol/Internet Protocol (TCP/IP) suite of protocols to communicate with one another. At the heart of the

Internet is a backbone of high-speed data communication lines between major nodes or host computers, consisting of thousands of commercial, governmental, educational and other computer systems that route data and messages. Of course, network 50 also may be implemented as a number of different types of networks, such as, for example, an intranet, local area network (LAN), or a wide area network (WAN). FIG. 1 is intended as an example, and not as an architectural limitation, for the different illustrative embodiments.

### Method of Operation:

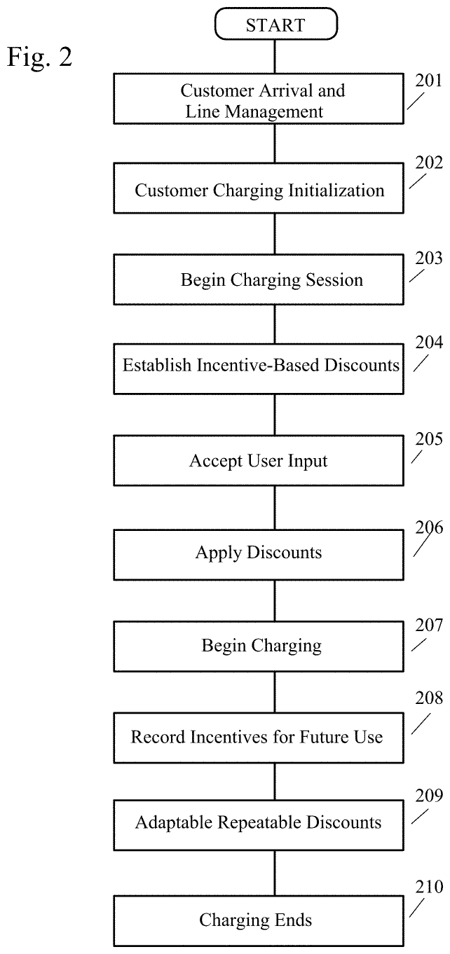

FIG. 2 shows a flowchart of a method of operating an electric vehicle charging station to optimize time spent at the station. It should be noted that prior to arriving to the station, in one embodiment, the user can schedule a “possible reservation” with the station through the electric vehicle. The “possible reservation” can include information associated with amount charge needed by the vehicle, current battery charge, the timing for arrival to the station or distance from the station, desired battery charge to exit the station with.

Step 201—CUSTOMER ARRIVAL & LINE MANAGEMENT: The customer arrives at the charging station with their electric vehicle in need of a charge. Customer waits in line for their turn at the charging station.

Step 202—CUSTOMER CHARGING INITIALIZATION: Customer establishes their vehicle's connection at the charging station.

Step 203—BEGIN CHARGING SESSION: As the vehicle is plugged in, the customer is notified via a display device. This could be a screen on the charging station or the vehicle, or some other communications device, such as an app on a smartphone or tablet or smart watch or the like. An advertisement can be selected to be shown to the customer at this time.

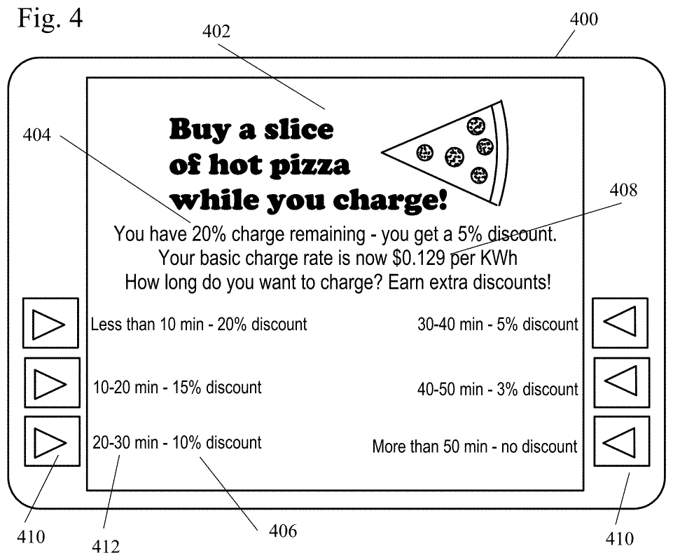

Step 204—ESTABLISH INCENTIVE-BASED DISCOUNTS: One or more discounts are determined based on changes in dynamic factors, and the discounts are displayed on the display device (see FIG. 4 for an example). The discounts can be applied either to the cost of the charge itself, or to a product or service being promoted. Data collected from systems of the vehicle can used to determine the applicable discounts for the user. For example, the user could be offered a discount on pizza or hamburgers at the associated mini-mart, or the discount could be applied to the cost of a car wash.

The discount starts at the greatest amount possible specified by the discount provider (ex. 20% off a product advertised) and decreases based on changes in dynamic factors such as time, battery charge percentage remaining, known distance to one or more other charging locations, known distance to destination, and other factors. Discounts can also be offered based on characteristics of the user, for example demographics (for example a discount for living in an area in which the vendor wants to increase sales), gender, age (for example, a senior citizens discount for drivers over sixty), sensor readings (for example the user's heart rate), or affiliations (for example, participation in a frequent-buyer rewards program, or membership in an organization such as Rotary or the AOPA, etc.). Discounts could also be offered for purchases of unrelated merchandise (for example, 5% off if you buy a cup of coffee and a donut while you wait), or for the location of car.

For example, suppose that the incentive offered is a percentage off on the purchase of an advertised product, and the method wishes to minimize the time the customer or user spends at the charter. The discount would then be set to decrease in value as the time at the charging station increase, for example:

TABLE 1
Example of varying discount based on charge time

| Time in Station | Discount |
|---|---|
| Less than 10 minutes | 20% |
| 10-20 minutes | 15% |
| 20-30 minutes | 10% |
| 30-40 minutes | 5% |
| 40-50 minutes | 3% |
| More than 50 minutes | No discount |

Other dynamic factors could be added to this, for example a charge-remaining discount based on the charge remaining in the vehicle's battery, which would incentivize a user to stop by and charge only when the remaining charge was within certain limits, for example:

TABLE 2
Example of varying discount based on charge remaining

| Charge Remaining | Discount |
|---|---|
| 10% or less | No discount |
| 10-20% | 5% |
| 20-30% | 10% |
| 30-50% | 5% |
| More than 50% | No discount |

Discounts might also be offered based on other factors derived from the user's known travel plans, for example, based on the distance to the next charging station on the user's route:

TABLE 3
Example of varying discount based on distance to next station

| Distance to Station | Discount |
|---|---|
| Less than 20 miles | No discount |
| 20-40 miles | 10% discount |
| 40-60 miles | 5% discount |
| More than 60 miles | No discount |

In this example, a discount is based on the distance to reach the next selected charging station, so that by selecting a nearer station to the user, the user is charged less than charging at the station that would require an increase in charge and time required to continue with the travel plans. For example, the charge remaining with a distance of 20-40 miles would be 20-30%, where the charge remaining for the station more than 60 miles away is 5%. It the user were to recharge at the station 20-40 miles away, the user would spend less time at this station than having to recharge almost the entire battery at the station more than 60 miles away and thus receive a discount.

The total discount offered to the user could be in the alternative, or could be the sum of the individual discounts shown above, or other factors.

FIG. 4 shows an example of a display screen 400, in a case where the vendor has chosen to implement the discounts shown in tables 1 and 2, above. The screen displays an ad 402 for pizza, shows the charge remaining in the vehicle's battery 404, and offers discounts 406 on the cost of the charge 408 based on the user's selection using buttons 410 of the charge time 412 they want.

Step 205—ACCEPT USER INPUT: This step depends on the discount structure selected by the operator. If the discount structure is set up to require the user to select a discount, as in the example of FIG. 4, the method will accept a user selection and apply a discount. Alternatively, the user may “select” a discount by, for example, operating the charger for a period of time and then disconnecting or pressing a “Stop” button or the like, in which case the system will wait until the user has stopped the charge cycle and determine the discount based on that time.

Step 206—APPLY DISCOUNTS: If the discount is applied to the charge cost, the price of the charge will be adjusted at this point. Optionally, if the discount is applied to a purchase, the charging station might print a coupon or transmit a message to a register inside the store, or create other indication which could be used at the register when purchasing the product.

Step 207—BEGIN CHARGING: Charging of the vehicle is started. Note that this step would be done after step 203 (Begin charging session), if the user input in step 205 was stopping the charge cycle or unplugging the vehicle after a time. Alternatively, this step 207 would be performed after applying discounts in step 206 if the user input in step 205 is, for example, selecting a discount or charging time from a list.

Step 208—RECORD INCENTIVES FOR FUTURE USE: Optionally, the system can record all of the incentives used by a consumer for future retrieval and use. The customer can be identified based on the VIN (Vehicle Identification Number) of their vehicle, or from their credit card, or a membership card in a rewards program, or by other means known to the art. The data recorded can include all past discounts offered and accepted or declined, customer preferences in types of advertisements,

Step 209—APPLICATION OF ADAPTABLE REPEATABLE DISCOUNTS: Optionally, the system can offer repeatable discounts to the customer. Repeatable discounts can be temporal in nature and unique to each vehicle's driver.

For example, discounts can be applied for every time a user charges their vehicle battery when the charging station is not busy. A station may use a subscription program which defines a discount relative to supply and demand usage at the station. The subscription program can have different levels defining usage—e.g. average, peak, or below average. Users may subscribe to charging their vehicle's battery only when usage is below average to gain the largest discount. The user could purchase such a subscription at the charging station or prior to charging station. For example, a large discount may be applied for a user which has purchased a subscription level of thirty below average charges at a particular charging station and therefore is limited to charging their vehicle's battery between 1 AM-4 AM.

Step 210—CHARGING ENDS: When the selected amount of charge has been added to the vehicle battery. The user removes the charging cord and drives off, freeing the charger for the next user. The user is charged for the electricity the user purchased, as is known to the art.

### EXAMPLE EMBODIMENTS

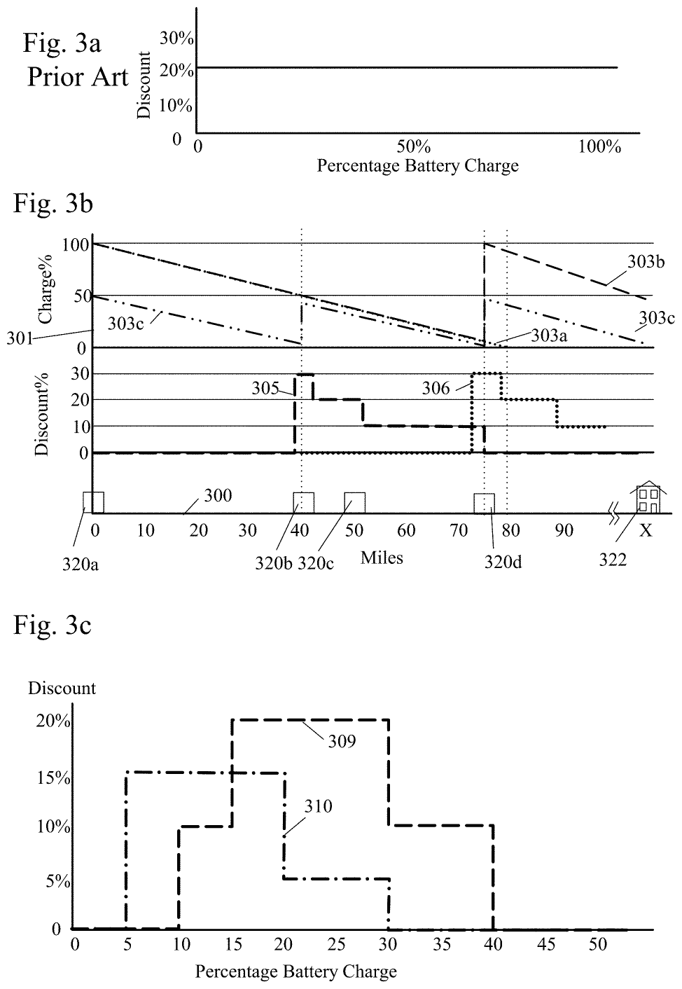

FIGS. 3a-3c show graphically how incentives can be applied.

For ease of explanation in these examples, assume that each full recharge takes 40 minutes, and battery charge percentage and charge time are linearly related, so that 20 minutes of charge gives 50% charge, etc. Battery charge is also assumed to be linearly related to miles traveled, so if at 40 minutes charging (100% charge) the maximum range of the vehicle is 80 miles, 30 second's charging (or 1.25% battery charge) provides one mile of range. In real-world applications, it will be understood that these relationships are not so simple, but variations can be adjusted for in a manner known to the art.

FIG. 3a shows an conventional example where the cost (or discount) is the same as the battery charge ranges from an empty battery all the way to a full battery.

FIG. 3b shows an example where the amount of discount is based on the known distance to the next charging station on the user's route. By reducing the discount after the state of charge in the battery exceeds that amount required to reach the charging station, the user is incentivized to leave this station and go on to the next charging station, where the user can recharge for the next leg of the journey. The graph of FIG. 3b has a horizontal axis 300 showing distance in miles from a charging station 320a at point 0, line 301 for discount level, and lines 303a-303c for charge level in the battery.

As shown in this example, the user's vehicle is at the charging station 320a at mile 0, and the user is going on to a destination 322 which is “X” miles away. As can be seen on the graph of FIG. 3b, there are charging stations 320b-320d along the user's route at 40, 50 and 75 miles away from the present charging station 320a at mile 0.

Dotted line 303a shows the battery charge if the vehicle is fully charged at the charging station at 0 and not recharged. As can be seen, “X” is greater than the maximum range of the vehicle—which is to say the battery charge line 303a reaches 0% before the user gets there. Therefore, the user knows that the user cannot reach that destination 322 without recharging and chooses to buy electricity at the charging station at mile 0.

Dashed line 303b shows the situation if the user puts a full charge on the user's battery at charging station 320a, which takes 40 minutes, and drives to the charging station 320d at 75 miles before recharging again for another 40 minutes. This is basically the present state of battery charging, where the vehicle driver always puts a full charge in the battery whenever the user can, and drives as far as the user can before recharging. The vehicle reaches the 75-mile charging station 320d with about 5% remaining charge, and fully recharges again. Assuming the use essentially out of charge when the user reached mile 0, and is close to that at mile 75, the user's total charge time is approximately 80 minutes.

By doing this the user will spend a longer time than optimal at the present charging station 320a, and also at the 75-mile charging station 320d, which not only wastes the user's time, but also wastes the time of others waiting in line behind the user.

It would minimize time at the mile 0 station 320a if the user would only add enough charge to reach the 40 mile charging station 320b, or perhaps the 50 mile station 320c. There is no point in the user adding less charge than the user needs to get to the 40 mile station 320b, or so much that the user can go beyond the 75 mile station 320d. Therefore, the system offers no discount for charging less than the user needs to reach the 40 mile station or past the 75 mile station. It offers a discount (dashed line 305) of 30% if the user adds just enough to get to the 40 mile station, 20% if the user adds enough to get to the 50 mile station, and 10% if the user adds enough to get to the 75 mile station.

The user chooses to get the highest discount, so the user adds only enough charge to reach the 40-mile station 320b, as showing by dash-dot line 303c. The user charges for 20 minutes, freeing up the charger in half the time as in the full-charge scenario, and drives to the 40-mile station 320b, where the user recharges again. If the 40-mile station 320b is using the same method of time optimization, the user will choose the user's charge time at that station to optimize the user's further discount (line 306), for example for another 25 minutes, so that the user arrives at the user's destination 322 of “X” with a reasonable reserve charge. Because of the method of optimization, the user has been incentivized to spend less time at the charging stations (45 minutes instead of 80 minutes), and the user's cost per mile is reduced by the maximum discount amount of 40%.

The example of FIG. 3c shows a case where the user needs to travel only 20 miles. The user should have at least 15% battery charge to do that, or 25% if the user wants to keep a safe 10% reserve when the user arrives. As the user passes a charging station, the user needs to make the decision if the user wants to stop to add more charge to the user's battery, or to drive on.

The method incentivizes the user to recharge at the charging station only if the user needs to, by offering discounts based on both the amount of charge the user has remaining and the amount of charge the user wants to add.

Dashed line 309 shows the remaining-charge discount and dot-dash line 310 shows the charge-added discount. As can be seen, the maximum remaining-charge discount of 20% is offered if the user recharges between 15% and 30% remaining charge, and lesser discounts of 10% are offered between 10%-15% and 30%-40%. Similarly, the maximum charge-added discount of 15% is in the range between 5% and 20% added charge, with a 5% discount for adding 20%-30%. Thus, the user has no incentive to let the user's battery run completely out of charge or to recharge more than the user needs to.

If the user chooses to recharge when the user already has much more charge than the user needs, and especially if the user chooses to fully recharge whether the user needs it or not, the user will be taking up a charging slot at the station which could be used by others, a non-optimal situation. If the user fully recharging when the user had 60% remaining charge—much more than the 25% the user needed with 10% reserve at destination. The user has to charge for 16 minutes to add the 40% additional charge, and receives no discount since the user is outside in the incentive range on both charge-remaining 309a and charge-added 309b lines.

In contrast, suppose the user chooses to wait until the user has 15% remaining charge. That is just enough to get home, which the user is not comfortable with, so the user stops at the charging station and only adds 10% charge. The user receives the maximum discount of 40%—the sum of 20% for recharging between 15-30% remaining charge, and 20% for adding between 5-15% more—and the user's charge time is only four minutes. The user returns home in 20 miles with the optimal 10% reserve.

FIG. 5 illustrates internal and external components of a device computer 52 and server computer 54 in which illustrative embodiments may be implemented. In FIG. 5, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Program 66 can be downloaded to the device computer 52 and server computer 54 from an external computer via a network (for example, the Internet, a local area network or other, wide area network) and network adapter or interface 836. From the network adapter or interface 836, Program 66 is loaded into hard drive 830. Program 66 can be downloaded to the server computer 54 from an external computer via a network (for example, the Internet, a local area network or other, wide area network) and network adapter or interface 836. From the network adapter or interface 836, Program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Program 66 can be written in various programming languages including low-level, high-level, object-oriented or non object-oriented languages. Alternatively, the functions of a program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of operating a charging station for an electric vehicle having a user and a battery having a charge, the method comprising the steps of:
a) accepting a connection initiated by the user of the vehicle connecting the vehicle to the charging station;
b) notifying the user of the connection via a display device;
c) determining at least one incentive-based discount based on at least one dynamic factor, the at least one discount being determined at least to incentivize the user toward spending less time at the charging station;
d) displaying the at least one incentive-based discount to the user through the display device;
e) accepting a user input;
f) determining an applicable discount from the user input; and
g) applying the discount.

2. The method of claim 1, in which the dynamic factor in step (c) comprises a distance to at least one charging station further along a route of the user.

3. The method of claim 2, in which there are a plurality of incentive-based discounts based on the distance to each of a plurality of charging stations further along a route of the user, and each of the discounts is determined so as to optimize a total charging time for the user along the route.

4. The method of claim 1, in which the dynamic factor in step (c) comprises a state of charge of the vehicle battery when the connection is initiated in step (a).

5. The method of claim 4, in which there are a plurality of incentive-based discounts based on the state of charge of the vehicle battery and each of the discounts is determined so as to optimize a total charging time for the user along the route.

6. The method of claim 1, in which the dynamic factor in step (c) comprises a distance to a destination of the user.

7. The method of claim 6, in which there are a plurality of incentive-based discounts determined based on the distance to the destination of the user, and each of the discounts is determined so as to incentivize the user to use the charger for a time which is sufficient to reach the destination, but less than the time for the vehicle battery to reach a full charge.

8. The method of claim 1, in which there are a plurality of incentive-based discounts determined in step (c) and in which step (d) of displaying the at least one incentive-based discount comprises displaying the plurality of incentive-based discounts to the user.

9. The method of claim 8, in which step (d) further comprises inviting the user to select one of the incentive-based discounts, and the user input accepted in step (e) is a selection of one of the plurality of incentive-based discounts.

10. The method of claim 8, in which each of the plurality of incentive-based discounts displayed to the user is associated with a time of charging, and the user input accepted in step (e) is a termination of charging within a time of charging associated with one of the plurality of incentive-based discounts.

11. The method of claim 1, in which the discount applied in step (g) is applied to a cost of the charging of the battery of the electric vehicle.

12. The method of claim 1, in which the discount applied in step (g) is applied to a cost of a product separate from the charging of the battery of the electric vehicle.

13. A computer program product for operating a charging station for an electric vehicle having a user and a battery having a charge, a computer of the charging station comprising at least one processor, one or more memories, one or more computer readable storage media, the computer program product comprising a computer readable storage medium having program instructions embodied therewith, the program instructions executable by the computer to perform a method comprising program instructions of:
a) accepting, by the computer, a connection initiated by the user of the vehicle connecting the vehicle to the charging station;
b) notifying, by the computer, the user of the connection via a display device;
c) determining, by the computer, at least one incentive-based discount based on at least one dynamic factor, the at least one discount being determined at least to incentivize the user toward spending less time at the charging station;
d) displaying, by the computer, the at least one incentive-based discount to the user through the display device;
e) accepting, by the computer, a user input;
f) determining, by the computer, an applicable discount from the user input; and
g) applying, by the computer, the discount.

14. The computer program product of claim 13, in which the dynamic factor in program instruction (c) comprises a distance to at least one charging station further along a route of the user.

15. The computer program product of claim 14, in which there are a plurality of incentive-based discounts based on the distance to each of a plurality of charging stations further along a route of the user, and each of the discounts is determined so as to optimize a total charging time for the user along the route.

16. The computer program product of claim 13, in which the dynamic factor in program instruction (c) comprises a state of charge of the vehicle battery when the connection is initiated in program instruction (a).

17. The computer program product of claim 16, in which there are a plurality of incentive-based discounts based on the state of charge of the vehicle battery and each of the discounts is determined so as to optimize a total charging time for the user along the route.

18. The computer program product of claim 13, in which the dynamic factor in program instruction (c) comprises a distance to a destination of the user.

19. The computer program product of claim 18, in which there are a plurality of incentive-based discounts determined based on the distance to the destination of the user, and each of the discounts is determined so as to incentivize the user to use the charger for a time which is sufficient to reach the destination, but less than the time for the vehicle battery to reach a full charge.

20. A computer system for operating a charging station for an electric vehicle having a user and a battery having a charge, the charging station comprising a computer comprising at least one processor, one or more memories, one or more computer readable storage media having program instructions executable by the computer to perform the program instructions comprising:
a) accepting, by the computer, a connection initiated by the user of the vehicle connecting the vehicle to the charging station;
b) notifying, by the computer, the user of the connection via a display device;
c) determining, by the computer, at least one incentive-based discount based on at least one dynamic factor, the at least one discount being determined at least to incentivize the user toward spending less time at the charging station;
d) displaying, by the computer, the at least one incentive-based discount to the user through the display device;
e) accepting, by the computer, a user input;
f) determining, by the computer, an applicable discount from the user input; and
g) applying, by the computer, the discount.
